(19) United States
(12) Patent Application Publication
(10) Pub. No.: US 2021/0042636 A1
(43) Pub. Date: Feb. 11, 2021

(54) INFORMATION PROCESSING APPARATUS, INFORMATION PROCESSING METHOD, AND PROGRAM

(71) Applicant: NEC CORPORATION, Tokyo (JP)

(72) Inventor: Hiroki NAKAYAMA, Tokyo (JP)

(73) Assignee: NEC CORPORATION, Tokyo (JP)

(21) Appl. No.: 16/977,891

(22) PCT Filed: Feb. 25, 2019
(86) PCT No.: PCT/JP2019/006957

§ 371 Date: Sep. 3, 2020

(30) Foreign Application Priority Data
Mar. 7, 2018 (JP) 2018-040991

(51) Int. Cl. G06N 5/02; G06N 5/04

(52) U.S. Cl. CPC G06N 5/025; G06N 5/04

(57) ABSTRACT

An information processing apparatus of the present invention includes a generation means for generating a plurality of rules for complementing a missing value in data including a plurality of attributes on the basis of a value of a specific attribute including the missing value and a value of another attribute that is different from the specific attribute, and a complementing means for specifying a value to complement the missing value on the basis of the rules.

### TECHNICAL FIELD

The present invention relates to an information processing apparatus, an information processing method, and a program, for complementing missing data.

### BACKGROUND ART

Analyzing available data and creating a model to predict the future have been performed in various scenes. However, when analyzing data, if data to be analyzed includes a missing value, it is difficult to perform prediction with high accuracy. Therefore, it is necessary to complement missing data with a probable value.

Patent Literature 1: WO 2014/199920 A

### SUMMARY

The method of complementing a missing value disclosed in Patent Literature 1 includes comprehensively learning samples having common explanatory variables that are not missing to thereby complement a missing value. However, in the method of complementing a missing value disclosed in Patent Literature 1, a missing pattern does not necessarily resemble another sample. Consequently, this causes a problem that a missing value in data cannot be complemented with a more appropriate value.

In view of the above, an object of the present invention is to provide an information processing apparatus, an information processing method, and a program, capable of solving the aforementioned problem, that is, a problem that a missing value in data cannot be complemented with a more appropriate value.

An information processing apparatus, according to one aspect of the present invention, is configured to include

a generation means for generating a plurality of rules for complementing a missing value in data including a plurality of attributes, on a basis of a value of a specific attribute including the missing value and a value of another attribute that is different from the specific attribute, and

a complementing means for specifying a value to complement the missing value on a basis of the plurality of the rules.

An information processing method, according to another aspect of the present invention, is configured to include

generating a plurality of rules for complementing a missing value in data including a plurality of attributes, on a basis of a value of a specific attribute including the missing value and a value of another attribute that is different from the specific attribute, and

specifying a value to complement the missing value on a basis of the plurality of the rules.

A program, according to another aspect of the present invention, is configured to cause an information processing apparatus to realize

a generation means for generating a plurality of rules for complementing a missing value in data including a plurality of attributes, on a basis of a value of a specific attribute including the missing value and a value of another attribute that is different from the specific attribute, and

a complementing means for specifying a value to complement the missing value on a basis of the plurality of the rules.

With the configurations described above, the present invention is able to improve the accuracy of a complementary value for a missing value in data having a plurality of attributes.

### BRIEF DESCRIPTION OF DRAWINGS

FIG. 1 is a block diagram illustrating a configuration of an information processing apparatus according to a first exemplary embodiment of the present invention.

FIG. 2 illustrates an example of data including missing values.

FIG. 3 is a flowchart illustrating an operation of the information processing apparatus disclosed in FIG. 1.

FIG. 4 illustrates a state of a complementing process on a missing value of data.

FIG. 5 illustrates a state of a complementing process on a missing value of data.

FIG. 6 illustrates a state of a complementing process on a missing value of data.

FIG. 7 illustrates a state of a complementing process on a missing value of data.

FIG. 8 illustrates a state when a missing value of data is complemented.

FIG. 9 is a block diagram illustrating a configuration of an information processing apparatus according to a second exemplary embodiment of the present invention.

### EXEMPLARY EMBODIMENTS

### First Exemplary Embodiment

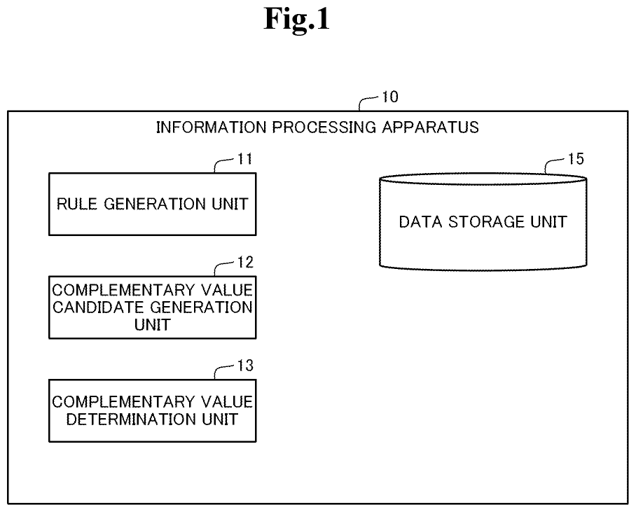

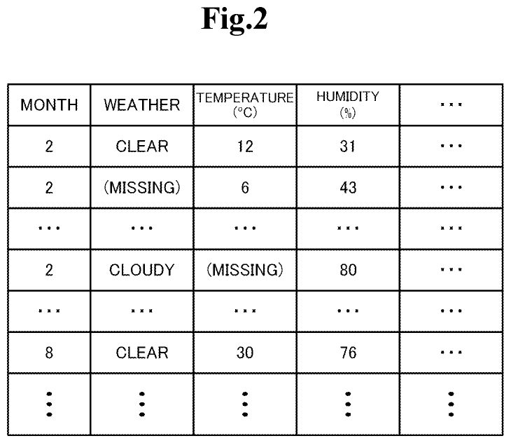

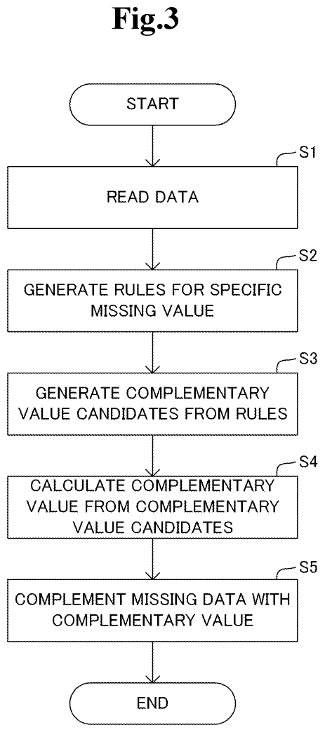

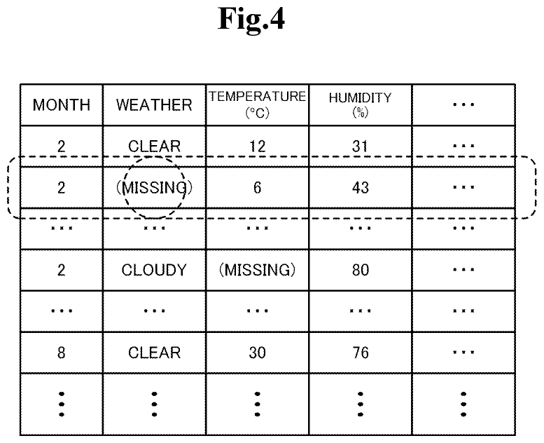

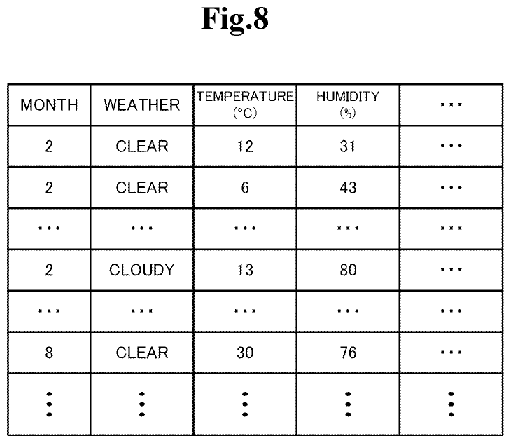

A first exemplary embodiment of the present invention will be described with reference to FIGS. 1 to 8. FIG. 1 is a block diagram illustrating a configuration of an information processing apparatus. FIG. 2 illustrates an example of data including missing values. FIG. 3 is a flowchart illustrating an operation of the information processing apparatus. FIGS. 4 to 7 illustrate a complementing process on a missing value of data. FIG. 8 illustrates a state when a missing value of data is complemented.

An information processing apparatus 1 according to the present invention is configured of one or more information processing apparatuses each having an arithmetic unit and a storage device. As illustrated in FIG. 1, the information processing apparatus 1 includes a rule generation unit 11, a complementary value candidate generation unit 12, and a complementary value determination unit 13 that are constructed by execution of a program by the arithmetic unit. The information processing apparatus 1 also includes a data storage unit 15 formed in the storage device. Hereinafter, detailed configuration and operation of the information processing apparatus 1 will be described.

The data storage unit 15 stores therein data to be analyzed as illustrated in FIG. 2. The data has a plurality of attributes such as month, weather, temperature, humidity, and the like. Specifically, the attribute “month” takes discrete values such as February and August, and the attribute “weather” also takes discrete values such as clear, cloudy, and rain. The attribute “temperature” and the attribute “humidity” take continuous values. Note that the values of the respective attributes on the same row are data observed at the same time.

Part of the data includes missing values. For example, in the example of FIG. 2, a value of the attribute “weather” on the second row and a value of the attribute “weather” on the fourth row are missing. As described below, the information processing apparatus 1 of the present invention performs a process of complementing such missing values. Note that the data stored in the data storage unit 15 is not limited to that illustrated in FIG. 2.

The rule generation unit 11 (generation means) first reads data having a missing value from the data storage unit 15 (step S1 in FIG. 3), and generates a rule to complement the missing value (step S2 in FIG. 3). At that time, the rule generation unit 11 generates a plurality of rules for complementing one missing value (given missing value). A specific method of generating rules will be described later.

Thereafter, the complementary value candidate generation unit 12 (complementing means) generates candidates for a complementary value for complementing the missing value, from the respective rules generated by the rule generation unit 11 (step S3 of FIG. 3). This means that the complementary value candidate generation unit 12 generates a plurality of candidates for a complementary value from the respective rules.

Then, the complementary value determination unit 13 (complementing means) calculates a complementary value from the candidates for the complementary value generated by the complementary value candidate generation unit 12 (step S4 of FIG. 13). Then, the complementary value determination unit 13 complements the missing value of the data with the specified complementary value, and stores it in the data storage unit 15 (step S5 in FIG. 3).

Here, a specific example of a process of complementing a missing value by the information processing apparatus 1 will be described. First, description will be given on a specific example of complementing a missing value of the attribute “weather” on the second row indicated by a circle of a dotted line in FIG. 4.

First, the rule generation unit 11 sets a combination of the attribute “weather” (specific attribute) having a missing value and another attribute. Here, three combinations, namely the attribute “weather” and the attribute “month”, the attribute “weather” and the attribute “temperature”, and the attribute “weather” and the attribute “humidity”, are set. Then, for each combination, a rule for complementing the missing value is generated.

In the combination of the attribute “weather” and the attribute “month”, a value of the attribute “month” corresponding to the missing part of the attribute “weather” is “February”, as being surrounded by a square of a dotted line in FIG. 4. Therefore, the values other than the missing value of the attribute “weather” corresponding to the value “February” of the attribute “month” are checked. In the data of the present embodiment, it is assumed that there are 100 units of data in which the attribute “month” is “February” and the attribute “weather” is not missing, and regarding the attribute “weather”, 70 units of data have a value “clear”, 60 units of data have a value “cloudy”, and 60 units of data have a value “rain”.

Therefore, from the combination of the attribute “weather” and the attribute “month”, in the case where the value of the attribute “month” is “February”, the rule generation unit 11 generates a rule for the attribute “weather” consisting of a probability distribution of “clear” 70%, “cloudy” 20%, and “rain” 40%. As described above, when both combined attributes have discrete values, the rule generation unit 11 generates a rule on the basis of the appearance frequency of the values of the attribute to be complemented, with respect to the value of the other attribute corresponding to the missing value.

Further, in the combination of the attribute “weather” and the attribute “temperature”, a value of the attribute “temperature” corresponding to the missing value of the attribute “weather” is “6° C.”, as being surrounded by a square of a dotted line in FIG. 4. Therefore, the values other than the missing value of the attribute “weather” corresponding to the value “6° C.” of the attribute “temperature” are checked. However, since the values of the other attribute “temperature”, not to be complemented, of the combined attributes have continuous values, values in a predetermined range including the value “6° C.” corresponding to the missing value is set, and appearance frequency of the values of the attribute “weather” to be complemented, with respect to the values of the predetermined range, is checked. Specifically, the other attribute “temperature” is sectioned by the class width of 5° C., and the appearance frequency of the attribute “weather” to be complemented, with respect to the attribute “temperature” of the range of “5° C. or higher and less than 10° C.” including the “6° C.”, is checked.

In the data of the present embodiment, there are 150 units of data in which the attribute “temperature” is in a range of “5° C. or higher and lower than 10° C.” and the attribute “weather” is not missing, and regarding the values of the attribute “weather”, it is assumed that 30 units of data have a value “fine”, 60 units of data have a value “cloudy”, and 60 units of data have a value “rain”. Therefore, from the combination of the attribute “weather” and the attribute “temperature”, the rule generation unit 11 generates a rule consisting of a probability distribution that “when the value of the attribute “temperature” is “5° C. or higher and lower than 10° C.”, in the attribute “weather”, “clear” is 20%, “cloudy” is 40%, and “rain” is 40%.

Further, in the combination of the attribute “weather” and the attribute “humidity”, a value of the attribute “humidity” corresponding to the missing value of the attribute “weather” is “43%”, as being surrounded by a square of a dotted line in FIG. 4. Therefore, the values other than the missing value of the attribute “weather” corresponding to the value “43%” of the attribute “temperature” are checked. However, since the value of the other attribute “humidity”, not to be complemented, of the combined attributes have continuous values, values in a predetermined range including the value “43%” corresponding to the missing value are set, and the appearance frequency of the value of the attribute “weather” to be complemented, with respect to the values of the predetermined range, is checked. Specifically, the other attribute “humidity” is sectioned by the class width of “10%”, and the appearance frequency of the attribute “weather” to be complemented, with respect to the attribute “humidity” in the range of “40% or higher and lower than 50%” including the “43%” is checked.

In the data of the present embodiment, there are 200 units of data in which the attribute “humidity” is in the range of “40% or higher and lower than 50%” and the attribute “weather” is not missing, and regarding the values of the attribute “weather”, it is assumed that 120 units of data have a value “clear”, 75 units of data have a value “cloudy”, and 5 units of data have a value “rain”. Therefore, from the combination of the attribute “weather” and the attribute “humidity”, the rule generation unit 11 generates a rule consisting of a probability distribution in which “when the value of the attribute “humidity” is “40% or higher and lower than 50%”, in the attribute “weather”, “clear” is 60%, “cloudy” is 35%, and “rain” is 5%”.

As described above, the rule generation unit 11 generates the following three rules as rules for complementing the missing value in the attribute “weather” shown in the second row of FIG. 4:

(a1) When the attribute “month” is “February”, in the attribute “weather”, “clear” is 70%, “cloudy” is 20%, and “rain” is 40%,

(a2) When the attribute “temperature” is “5° C. or higher and lower than 10° C.”, in the attribute “weather”, “clear” is 20%, “cloudy” is 40%, and “rain” is 40%, and

(a3) When the attribute “humidity” is “40% or higher and lower than 50%”, in the attribute “weather”, “clear” is 60%, “cloudy” is 35%, and “rain” is 5%.

Then, the complementary value candidate generation unit 12 generates a candidate for a complementary value of the attribute “weather” from each of the three rules. For example, in the case where a value of the weather having the highest probability is determined to be a candidate for a complementary value in each of the three rules, three candidates for the complementary value are generated including a candidate “clear” for the complementary value from the rule (a1), a candidate “cloudy” for the complementary value from the rule (a2), and a candidate “clear” for the complementary value from the rule (a3).

Then, the complementary value determination unit 13 integrates the three candidates for the complementary value generated from the three rules to specify a final complementary value for complementing the missing value of the attribute “weather”. For example, specifying the complementary value is performed based on the number of candidates for the complementary value. In this case, since the candidate “clear” for the complementary value are generated from the two of the three rules, the complementary value is determined to be “clear” according to the majority decision. However, the complementary value may be specified by means of another method. For example, an average value of the candidates for the complementary value may be used, or it is possible to perform weighting set for each attribute on the candidates for the complementary value and then determine the value according to the majority decision. For example, in the case where the weighting for the attributes “month” and “humidity” is “1” and the weighting for the attribute “temperature” is “3”, the candidate “cloudy” for the complementary value generated from the rule (a2) is specified as the complementary value according to the majority decision.

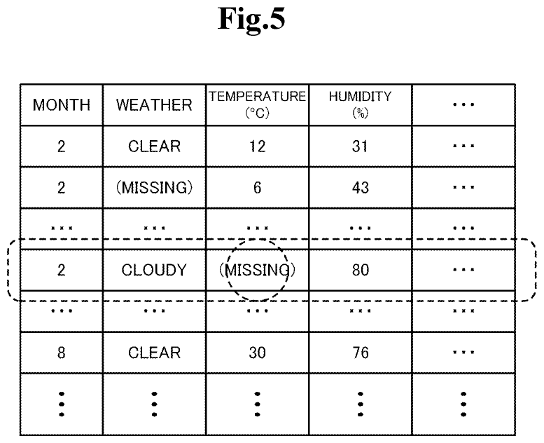

Next, as a specific example of a process of complementing a missing value by the information processing apparatus 1, the case of complementing the missing value of the attribute “temperature” on the fourth row, shown by a circle of a dotted line in FIG. 5, will be described.

First, the rule generation unit 11 sets a combination of the attribute “temperature” (specific attribute) having a missing value and another attribute. Here, three combinations, that is, the attribute “temperature” and the attribute “month”, the attribute “temperature” and the attribute “weather”, and the attribute “temperature” and the attribute “humidity”, are set. Then, for each combination, a rule for complementing the missing value is generated.

In the combination of the attribute “temperature” and the attribute “month”, a value of the attribute “month” corresponding to the missing part of the attribute “temperature” is “February”, as being surrounded by a square of a dotted line in FIG. 5. Therefore, the values other than the missing value of the attribute “temperature”, corresponding to the value “February” of the attribute “month”, are checked. However, since the values of the attribute “temperature” to be complemented, of the combined attributes, are continuous values, values in a predetermined range of the attribute “temperature” are set, and the appearance frequency of the values in the predetermined range of the attribute “temperature”, with respect to the value “February” of the attribute “month”, is checked. Specifically, the values of the attribute “temperature” to be complemented are sectioned by a class width of 5° C., and the appearance frequency of the temperature in the 5° C. width is checked.

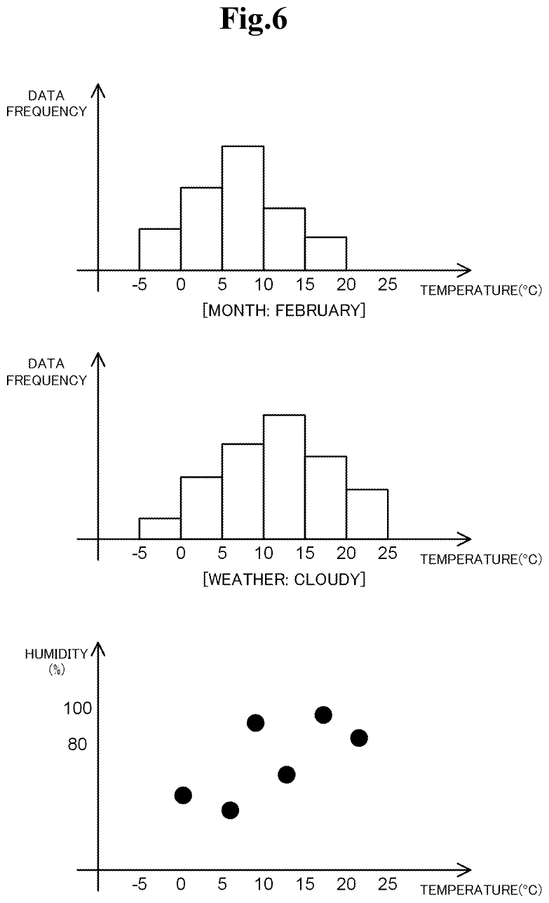

A histogram shown at the top of FIG. 6 illustrates the appearance frequency of 5° C. width of the attribute “temperature” with respect to the value “February” of the attribute “month”. Therefore, from the combination of the attribute “temperature” and the attribute “month”, the rule generation unit 11 generates a rule that “when the value of the attribute “month” is “February”, the frequency of the attribute “temperature” is represented by the frequency distribution shown at the top of FIG. 6″.

Further, in the combination of the attribute “temperature” and the attribute “weather”, a value of the attribute “weather” corresponding to the missing value of the attribute “temperature” is “cloudy”, as being surrounded by a square of a dotted line in FIG. 5. Therefore, the values other than the missing value of the attribute “temperature”, corresponding to the value “cloudy” of the attribute “weather”, are checked. However, since the values of the attribute “temperature” to be complemented, of the combined attributes, are continuous values, values in a predetermined range of the attribute “temperature” are set, and the appearance frequency of the values in the predetermined range of the attribute “temperature”, with respect to the value “cloudy” of the attribute “weather”, is checked. Specifically, the values of the attribute “temperature” to be complemented are sectioned by a class width of 5° C., and the appearance frequency of the temperature in the 5° C. width is checked.

A histogram shown in the middle of FIG. 6 illustrates the appearance frequency of 5° C. width of the attribute “temperature” with respect to the value “cloudy” of the attribute “weather”. Therefore, from the combination of the attribute “temperature” and the attribute “weather”, the rule generation unit 11 generates a rule that when the value of the attribute “weather” is “cloudy”, the frequency of the attribute “temperature” is represented by the frequency distribution shown in the middle of FIG. 6.

Further, in the combination of the attribute “temperature” and the attribute “humidity”, a value of the attribute “humidity” corresponding to the missing value of the attribute “temperature” is “80%”, as being surrounded by a square of a dotted line in FIG. 5. Therefore, the values other than the missing value of the attribute “temperature”, corresponding to the value “80%” of the attribute “humidity”, are checked. However, since both combined attributes have continuous values, a scatter diagram of the values is generated. That is, on a plane formed of the values of the two combined attributes, dots showing the two attributes located on the same row are plotted. At this time, data in which the attribute “temperature” is missing is excluded, of course.

A scatter diagram of the values of the attribute “temperature” and the values of the attribute “humidity” is formed as shown at the bottom of FIG. 6. Therefore, from the combination of the attribute “temperature” and the attribute “humidity”, the rule generation unit 11 generates a rule that the relationship between the values of the attribute “temperature” and the values of the attribute “humidity” is represented by the scatter diagram shown at the bottom of FIG. 6.

As described above, as rules for complementing the missing value in the attribute “temperature” shown in the fourth row of FIG. 5, the rule generation unit 11 generates the three rules respectively represented by the graphs such as a frequency distribution and a scatter diagram of FIG. 6.

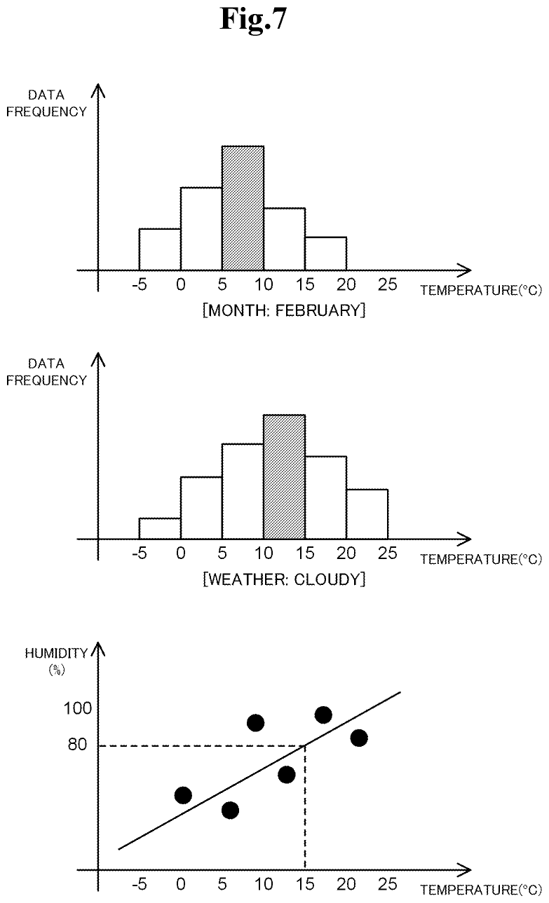

Then, the complementary value candidate generation unit 12 generates candidates for the complementary value of the attribute “temperature” from the three rules, respectively. For example, from the frequency distribution at the top of FIG. 6, a range of “5° C. or higher and lower than 10° C.” that is a frequency having the largest values of the attribute “temperature”, as shown by the hatched part at the top of FIG. 7, is selected, and “9° C.” is generated as a candidate for the complementary value from the numerical values within the range. While “9° C.” is selected at random as a candidate for the complementary value from the range of “5° C. or higher and lower than 10° C.” in this example, a candidate for the complementary value may be generated by any method. Similarly, from the frequency distribution in the middle of FIG. 6, a frequency range of “10° C. or higher and lower than 15° C.” that is a frequency having the largest number of values of the attribute “temperature”, as shown by the hatched part in the middle of FIG. 7, is selected, and “16° C.” is generated as a candidate for the complementary value from the numerical values within the range.

Further, from the scatter diagram at the bottom of FIG. 6, an approximation straight line is calculated as shown at the bottom of FIG. 7. Then, from the approximation straight line, a value “15° C.” of the attribute “temperature” corresponding to the value “80%” of the attribute “humidity” on the same row as the missing value of the attribute “temperature” is selected. Further, for the attribute “temperature”, a normal distribution having an average of “15° C.” is generated, and based on the normal distribution, “14° C.” is generated as a candidate for the complementary value. Note that the method of generating a candidate for the complementary value from the scatter diagram is not limited to that described above, and any method may be used.

Then, the complementary value determination unit 13 integrates the three candidates for the complementary value generated from the three rules to specify a final complementary value for complementing the missing value of the attribute “temperature”. For example, specifying a complementary value is performed by calculating an average of the candidates for the complementary value. In this case, an average of the candidates for the complementary value generated from the three rules is “13° C.”, and this value is specified as the complementary value. However, the complementary value may be specified from another method. For example, an average value may be generated by performing weighting set for each attribute on the candidates for the complementary value. For example, in the case where the weighting for the attribute “month” is “2” and the weighting for the attributes “humidity” and “weather” is “1”, the complementary value is specified as “12° C.” from the values of the candidates for the complementary value.

Then, the specified complementary value is used to complement the data missing part as illustrated in FIG. 8 by the complementary value determination unit 13, and is stored in the data storage unit 15. Thereby, the data in which the missing value is complemented can be used for data analysis.

As described above, the information processing apparatus 1 of the present invention generates a plurality of rules for complementing a missing value of data and generates a complementary value from the rules. Therefore, it is possible to predict a missing value of data from every relationship among a plurality of attributes, and to generate a more appropriate complementary value.

In the above description, an example of complementing one missing value from a plurality of rules has been provided. However, it is possible to complement a plurality of missing values from a plurality of rules at once. For example, when there are a plurality of missing values, it is possible to generate at least one rule for complementing each missing value to thereby generate a plurality of rules as a whole, and to complement the missing values from the rules.

### Second Exemplary Embodiment

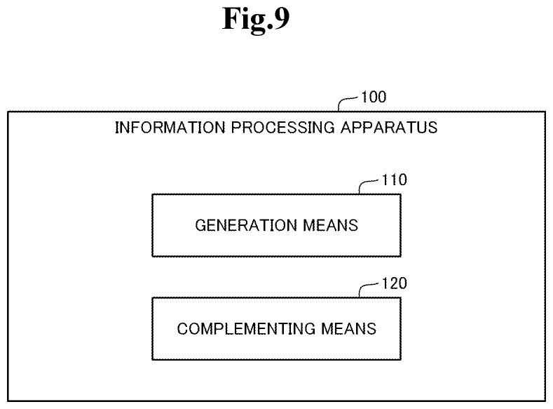

Next, a second exemplary embodiment of the present invention will be described with reference to FIG. 9. FIG. 9 is a block diagram illustrating a configuration of an information processing apparatus according to the second exemplary embodiment. Note that the present embodiment shows the outline of the configuration of the information processing apparatus described in the first exemplary embodiments.

As illustrated in FIG. 9, an information processing apparatus 100 of the present embodiment includes

a generation means 110 for generating a plurality of rules for complementing a missing value in data including a plurality of attributes, on the basis of a value of a specific attribute including the missing value and a value of another attribute that is different from the specific attribute, and

a complementing means 120 for specifying a value to complement the missing value on the basis of the rules.

Note that the generation means 110 and the complementing means 120 are implemented by execution of a program by the information processing apparatus.

The information processing apparatus 100 having the above-described configuration operates to execute the processing of

generating a plurality of rules for complementing a missing value in data including a plurality of attributes, on the basis of a value of a specific attribute including the missing value and a value of another attribute that is different from the specific attribute, and

specifying a value to complement the missing value on the basis of the rules.

According to the invention described above, a plurality of rules for complementing a missing value of data are generated from values of a plurality of attributes, and a complementary value is generated from the rules. Therefore, it is possible to predict a missing value of data from the rules representing the relationship between the attributes, and to generate a more appropriate complementary value.

### <Supplementary Notes>

The whole or part of the exemplary embodiments disclosed above can be described as, but not limited to, the following supplementary notes. Hereinafter, outlines of the configurations of an information processing apparatus, an information processing method, and a program, according to the present invention, will be described. However, the present invention is not limited to the configurations described below.

### (Supplementary Note 1)

An information processing apparatus comprising:

generation means for generating a plurality of rules for complementing a missing value in data including a plurality of attributes, on a basis of a value of a specific attribute including the missing value and a value of another attribute that is different from the specific attribute; and

a complementing means for specifying a value to complement the missing value on a basis of the plurality of the rules.

### (Supplementary Note 2)

The information processing apparatus according to supplementary note 1, wherein

the generating means generates the plurality of the rules for complementing a given missing value of the specific attribute, and

the complementing means specifies a value to complement the given missing value of the specific attribute on a basis of the plurality of the rules.

### (Supplementary Note 3)

The information processing apparatus according to supplementary note 2, wherein

when forming a combination of a value of the specific attribute and a value of the other attribute, the generation means forms a plurality of combinations by changing the other attribute to be combined with the value of the specific attribute to a different attribute, and generates the plurality of the rules for complementing the given missing value on a basis of the plurality of combinations, respectively.

### (Supplementary Note 4)

The information processing apparatus according to supplementary note 2 or 3, wherein

the generation means generates at least two of the rules including:

a first rule for complementing the given missing value on a basis of a value of the specific attribute and a value of a first attribute that is the other attribute; and

a second rule for complementing the given missing value on a basis of a value of the specific attribute and a value of a second attribute that is another attribute different from the first attribute.

### (Supplementary Note 5)

The information processing apparatus according to any of supplementary notes 2 to 4, wherein

the generation means generates one of the rules on a basis of appearance frequency of a value of the specific attribute with respect to a value of the other attribute corresponding to the given missing value of the specific attribute.

### (Supplementary Note 6)

The information processing apparatus according to supplementary note 5, wherein

in a case where the value of the other attribute is a continuous value, the generation means generates one of the rules on a basis of the appearance frequency of the value of the specific attribute with respect to a value in a predetermined range including the value of the other attribute corresponding to the given missing value of the specific attribute.

### (Supplementary Note 6.1)

The information processing apparatus according to claim 5 or 6, wherein

in a case where the value of the specific attribute is a continuous value, the generation means generates one of the rules on a basis of appearance frequency of a value in a predetermined range of the specific attribute with respect to the value of the other attribute corresponding to the given missing value of the specific attribute.

### (Supplementary Note 7)

The information processing apparatus according to any of supplementary notes 5 to 6.1, wherein

in a case where the value of the specific attribute and the value of the other attribute are continuous values, the generation means generates one of the rules on a basis of a scatter diagram of values excluding the given missing value of the specific attribute and values of the other attribute corresponding to the values excluding the given missing value of the specific attribute.

### (Supplementary Note 8)

The information processing apparatus according to any of claims 2 to 7, wherein the complementing means generates a plurality of candidates for a value to complement the given missing value of the specific attribute on a basis of the plurality of the rules respectively, and specifies a value to complement the given missing value of the specific attribute on a basis of the plurality of the candidates.

### (Supplementary Note 9)

An information processing method comprising:

generating a plurality of rules for complementing a missing value in data including a plurality of attributes, on a basis of a value of a specific attribute including the missing value and a value of another attribute that is different from the specific attribute; and

specifying a value to complement the missing value on a basis of the plurality of the rules.

### (Supplementary Note 9.1)

The information processing method according to supplementary note 9, further comprising:

generating the plurality of the rules for complementing a given missing value of the specific attribute; and

specifying a value to complement the given missing value of the specific attribute on a basis of the plurality of the rules.

### (Supplementary Note 9.2)

The information processing method according to supplementary note 9.1, further comprising

when forming a combination of a value of the specific attribute and a value of the other attribute, forming a plurality of combinations by changing the other attribute to be combined with the value of the specific attribute to a different attribute, and generating the plurality of the rules for complementing the given missing value on a basis of the plurality of the combinations respectively.

### (Supplementary Note 9.3)

The information processing method according to supplementary note 9.1 or 9.2, further comprising

generating a plurality of candidates for a value to complement the given missing value of the specific attribute on a basis of the plurality of the rules respectively, and specifying a value to complement the given missing value of the specific attribute on a basis of the plurality of the candidates.

### (Supplementary Note 10)

A program for causing an information processing apparatus to realize:

generation means for generating a plurality of rules for complementing a missing value in data including a plurality of attributes, on a basis of a value of a specific attribute including the missing value and a value of another attribute that is different from the specific attribute; and

complementing means for specifying a value to complement the missing value on a basis of the plurality of the rules.

Note that the program described above is stored using a non-transitory computer readable medium of any type, and can be supplied to a computer. A non-transitory computer readable medium includes a tangible storage medium of any type. Examples of a non-transitory computer readable medium include a magnetic recording medium (for example, flexible disk, magnetic tape, hard disk drive), a magneto-optical recording medium (for example, magneto-optical disk), a CD-ROM (Read Only Memory), a CD-R, a CD-R/W, and a semiconductor memory (for example, a mask ROM, a PROM (Programmable ROM), an EPROM (Erasable PROM), a flash ROM, and a RAM (Random Access Memory)). Further, the program may be supplied to a computer by a transitory computer readable medium of any type. Examples of a transitory computer readable medium include an electrical signal, an optical signal, and an electromagnetic wave. A transitory computer readable medium can supply the program to a computer via a wired communication channel such as an electric wire and an optical fiber, or a wireless communication channel.

While the present invention has been described with reference to the exemplary embodiments described above, the present invention is not limited to the above-described embodiments. The form and details of the present invention can be changed within the scope of the present invention in various manners that can be understood by those skilled in the art.

The present invention is based upon and claims the benefit of priority from Japanese patent application No. 2018-040991, filed on Mar. 7, 2018, the disclosure of which is incorporated herein in its entirety by reference.

### REFERENCE SIGNS LIST

10 information processing apparatus
11 rule generation unit
12 complementary value candidate generation unit
13 complementary value determination unit
15 data storage unit
100 information processing apparatus
110 generation means
120 complementing means

1. An information processing apparatus comprising:
a memory storing instructions; and
at least one processor configured to execute the instructions, the instructions comprising:
generating a plurality of rules for complementing a missing value in data including a plurality of attributes, based on a value of a specific attribute including the missing value and a value of another attribute that is different from the specific attribute; and
specifying a value to complement the missing value based on the plurality of the rules.

2. The information processing apparatus according to claim 1, wherein
the at least one processor
generates the plurality of the rules for complementing a given missing value of the specific attribute, and
specifies a value to complement the given missing value of the specific attribute based on the plurality of the rules.

3. The information processing apparatus according to claim 2, wherein
when forming a combination of a value of the specific attribute and a value of the other attribute, the at least one processor forms a plurality of combinations by changing the other attribute to be combined with the value of the specific attribute to a different attribute, and generates the plurality of the rules for complementing the given missing value based on the plurality of combinations, respectively.

4. The information processing apparatus according to claim 2, wherein
the at least one processor generates at least two of the rules including:
a first rule for complementing the given missing value based on a value of the specific attribute and a value of a first attribute that is the other attribute; and
a second rule for complementing the given missing value based on a value of the specific attribute and a value of a second attribute that is another attribute different from the first attribute.

5. The information processing apparatus according to claim 2, wherein
the at least one processor generates one of the rules based on appearance frequency of a value of the specific attribute with respect to a value of the other attribute corresponding to the given missing value of the specific attribute.

6. The information processing apparatus according to claim 5, wherein
in a case where the value of the other attribute is a continuous value, the at least one processor generates one of the rules based on the appearance frequency of the value of the specific attribute with respect to a value in a predetermined range including the value of the other attribute corresponding to the given missing value of the specific attribute.

7. The information processing apparatus according to claim 5, wherein
in a case where the value of the specific attribute is a continuous value, the at least one processor generates one of the rules based on appearance frequency of a value in a predetermined range of the specific attribute with respect to the value of the other attribute corresponding to the given missing value of the specific attribute.

8. The information processing apparatus according to claim 5, wherein
in a case where the value of the specific attribute and the value of the other attribute are continuous values, the at least one processor generates one of the rules based on a scatter diagram of values excluding the given missing value of the specific attribute and values of the other attribute corresponding to the values excluding the given missing value of the specific attribute.

9. The information processing apparatus according to claim 2, wherein
the at least one processor generates a plurality of candidates for a value to complement the given missing value of the specific attribute based on the plurality of the rules respectively, and specifies a value to complement the given missing value of the specific attribute based on the plurality of the candidates.

10. An information processing method comprising:
generating a plurality of rules for complementing a missing value in data including a plurality of attributes, based on a value of a specific attribute including the missing value and a value of another attribute that is different from the specific attribute; and
specifying a value to complement the missing value based on the plurality of the rules.

11. The information processing method according to claim 10, further comprising:
generating the plurality of the rules for complementing a given missing value of the specific attribute; and
specifying a value to complement the given missing value of the specific attribute based on the plurality of the rules.

12. The information processing method according to claim 11, further comprising
when forming a combination of a value of the specific attribute and a value of the other attribute, forming a plurality of combinations by changing the other attribute to be combined with the value of the specific attribute to a different attribute, and generating the plurality of the rules for complementing the given missing value based on the plurality of the combinations respectively.

13. The information processing method according to claim 11, further comprising
generating a plurality of candidates for a value to complement the given missing value of the specific attribute based on the plurality of the rules respectively, and specifying a value to complement the given missing value of the specific attribute based on the plurality of the candidates.

14. A non-transitory computer-readable medium storing a program comprising instructions for causing an information processing apparatus to execute processing of:
generating a plurality of rules for complementing a missing value in data including a plurality of attributes, based on a value of a specific attribute including the missing value and a value of another attribute that is different from the specific attribute; and
specifying a value to complement the missing value based on the plurality of the rules.
